(19) United States
(12) Patent Application Publication
(10) Pub. No.: US 2025/0205746 A1
(43) Pub. Date: Jun. 26, 2025

(54) SORTING DEVICE WITH A SHIELDED DETECTION ARRANGEMENT

(71) Applicant: OPTIMUM N.V., Hasselt (BE)

(72) Inventors: Ed DRIESEN, HasseIt (BE); Paul BERGHMANS, HasseIt (BE); Jan DEJONGHE, HasseIt (BE); Gert MINNART, HasseIt (BE)

(21) Appl. No.: 18/848,231

(22) PCT Filed: Mar. 21, 2023
(86) PCT No.: PCT/IB2023/052748

§ 371 Date: Sep. 18, 2024

(30) Foreign Application Priority Data
Mar. 21, 2022 (BE) BE 2022/15201

(51) Int. Cl. B07C 5/342; B07C 5/36

(52) U.S. Cl. CPC B07C 5/3422; B07C 5/366

(57) ABSTRACT

Sorting device and method for detecting irregularities in a product flow (1) moving in free flight through a detection zone (10), with a detection device (11) provided for detecting irregular products (6) in the product flow (1). The detection device (11) is separated from the product flow (1) by a closed wall (16) having at least one window (17) so that the product flow (1) can be detected by the detection device (11). This window (17) is shielded from the product flow (1) by a disc-shaped element (18) which can be driven around a rotational axis (19) in order to remove contaminants from said element (18).

The invention relates to a sorting device with a detection zone for detecting irregular products in a product flow, wherein the products of the product flow move in free-flight through the detection zone in a direction of travel. A detection device is provided to detect irregular products in the product flow. This detection device is separated from the product flow by a closed wall with at least one window so that the product flow can be observed through this window with the aid of the detection device while moving through the detection zone.

In such sorting devices, the products to be sorted are supplied to the detection zone by means of a conveying device, such as a conveyor belt or an inclined sliding plate. The products preferably leave the conveying device at a substantially uniform speed and then move in free flight through said detection zone.

The products moving through the detection zone are observed by said detection device in order to determine whether a product is irregular. The detection device cooperates with a removal device to remove irregular products from the product flow.

In order to detect irregular products as accurately as possible with the aid of the detection device and subsequently remove them correctly from the product flow, it is important that the detection and removal take place almost immediately after the products have left the conveying device. In addition, it is appropriate to inspect the products both at the top of the product flow and at the bottom of the product flow in order to obtain an optimal sorting result wherein substantially all irregular products are removed from the product flow.

Thus, the aim is to place a detection device under the product flow in such a way that products are inspected at the bottom at a very short distance behind the conveying device, almost immediately after they have left the latter. However, this entails the major disadvantage that all sorts of contaminants, dust particles, water, etc. which are carried along with the product flow, will settle on the detection device when leaving the conveying device or as irregular products are removed. This can seriously disrupt the operation of the detection device, so that the sorting result obtained with the sorting device becomes inadequate. The problem arises especially when sorting contaminated products or wet products, such as frozen vegetables, potatoes, nuts, etc. In addition, the trajectory of particles that are removed from the product flow is difficult to control, and sometimes these particles end up on the surface of the detection device.

The invention aims to remedy these disadvantages and propose a sorting device in which a detection device is provided which allows inspection of the bottom side of the product flow almost immediately upon leaving the conveying device in order to enable accurate removal of irregularities from the product flow, wherein the operation of the detection device remains substantially unaffected by all sorts of contaminants, dust particles, water, removed particles, etc. which are carried along with the product flow.

To this end, said window is shielded from the product flow by means of a disc-shaped element which is transparent to the detection device and can be driven around a rotational axis in order to remove contaminants from said element, said rotational axis extending substantially perpendicular to the surface of the disc-shaped element.

Practically, said window is provided at a level situated below the level of said detection zone in order to observe the bottom side of the product flow.

In an advantageous manner, said rotational axis extends substantially transverse to the plane of said window.

In an interesting embodiment of the sorting device according to the invention, said detection device comprises at least one camera whose field of view through said window extends over at least a part of the detection zone, so that products moving through this part of the detection zone can be observed by the camera.

According to a preferred embodiment of the sorting device according to the invention, the detection device comprises a camera on each lateral side of the product flow provided with an associated window wherein the field of view of the combined cameras extends over the entire detection zone.

According to a particular embodiment of the sorting device according to the invention, it has a conveying device with a conveyor surface for the products of said product flow extending upstream of said detection zone and connected thereto, so that products will move through the detection zone as they leave said surface.

Preferably, according to the invention, the sorting device comprises at least one light source extending below said detection zone and making it possible to illuminate products moving through the detection zone in order to improve the perception thereof by the detection device.

The invention also relates to a method for detecting irregularities in a product flow, with products of said product flow moving in free flight through a detection zone while being inspected by means of a detection device, wherein irregular products are identified. These irregular products are removed from the product flow during said free flight. The detection device is shielded from the product flow by means of a closed wall in which at least one window is provided so that the detection device can observe said product flow through said window.

This method is characterised in that said window is shielded from the product flow by placing a disc-shaped element, which is transparent to the detection device, between the window and the product flow. This disc-shaped element is driven around a central axis of rotation which extends substantially perpendicular to the surface of the disc-shaped element in order to remove contaminants from this element.

Other particularities and advantages of the invention will become apparent from the following description of specific embodiments of the sorting device and method according to the invention. This description is given as an example only and does not limit the scope of the claimed protection in any way; the reference numerals used hereinafter refer to the figures appended hereto.

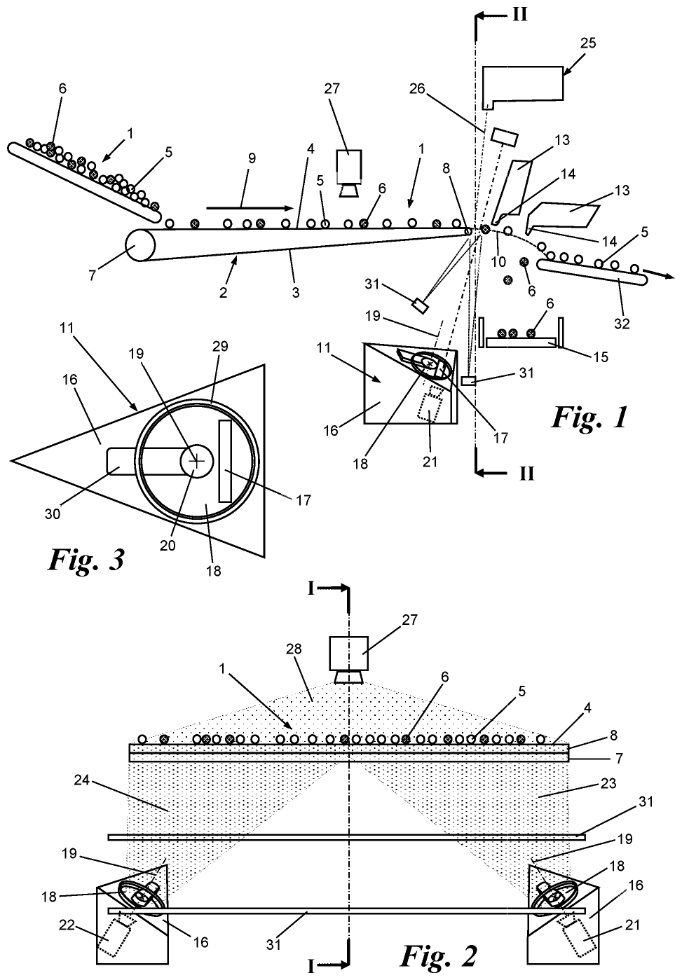

FIG. 1 is a schematic vertical longitudinal section, according to line I-I from FIG. 2, of a sorting device according to the invention.

FIG. 2 is a schematic vertical transverse section, according to line II-II from FIG. 1, of the sorting device according to the invention.

FIG. 3 is a schematic top view of a disc-shaped element mounted in front of a window of the detection device of a sorting device, as in the sorting device represented in FIGS. 1 and 2.

In the different figures, the same reference numerals refer to the same or analogous elements.

The invention generally relates to a sorting device in which products in a product flow to be sorted are optically sorted on the basis of discolorations, size and/or shape deviations, structural properties, etc. Products not wanted in the sorted product flow are regarded as irregular and, after detection, are removed from the product flow. In such sorting devices, irregular products are usually detected by means of camera observations or by analysing the reflection of incident light beams on the products, such as lasers.

FIG. 1 schematically shows a longitudinal section of an interesting embodiment of a sorting device according to the invention. In this sorting device, a product flow 1, which is to be sorted, is supplied to a conveying device 2. In the proposed embodiment, this conveying device 2 is formed by a conveyor belt 3 which has a conveyor surface 4 on which the products to be sorted supplied from the product flow 1 are distributed. This product flow 1 contains both suitable products 5 and irregular products 6 which are to be removed from the product flow 1 by the sorting device.

The conveyor belt 3 forms a closed loop running over two parallel cylindrical rollers 7 and 8, and it is driven such that the product flow 1, which rests on the conveyor surface 4 thereof, moves in a direction of travel indicated by arrow 9. The products 5 and 6 from the product flow are thereby distributed over substantially the entire width of the conveyor belt 3 in a layer with a single product thickness, as shown for example in FIGS. 1 and 2.

According to an alternative embodiment of the sorting device according to the invention, said conveyor surface 4 is formed by an inclined, straight or curved sliding plate. The products thereby move over this conveyor surface 4 under the influence of gravity. A sorting device with a curved sliding plate is described, for example, in document U.S. Pat. No. 6,305,551.

The products 5 and 6 thus move in said product flow 1 at a certain speed according to said direction of travel 9 over the conveying device 2 to the far end of the conveyor surface 4. At said end, the products 5 and 6 leave the conveyor surface 4 and, due to their inertia, move further in free flight through a detection zone 10. This detection zone 10 consequently connects downstream to the conveyor surface 4 and extends over at least the width of the product flow 1. The conveyor belt 3 is driven in a direction perpendicular to the detection zone 10.

During the movement of the products 5 and 6 through the detection zone 10, they are being observed by a detection device 11 which allows to identify irregular products 6 in the product flow 1 and to determine the position of these irregular products 6. In order to remove the identified irregular products 6 from the product flow 1 during said free flight, the detection device cooperates with a removal device 12.

The removal device 12 comprises, for example, a valve bar 13 with a row of successive compressed air valves 14 located next to each other, extending over the width of the product flow 11. The valve bar 13 is positioned above the product flow 1, with the compressed air valves directed towards the product flow 1. In order to remove an irregular product 6 from the product flow, one or more valves which are in a position corresponding to that of the product 6 to be removed will be activated, so that a directed air flow, originating from the activated valves 14, blows the product 6 out of the product flow 1. The removed product 6 then falls further down into a lower conveyor chute 15 which ensures the discharge of irregular products 6 that have been removed from the product flow 1.

In the embodiment of the sorting device shown in FIG. 1, two valve bars 13 are provided above the product flow 1. Obviously, also other systems are possible for removing irregular products 6 from the product flow 1.

According to the invention, the detection device 11 is separated from the product flow 1 by a closed wall 16. A window 17 is present in this wall 16, so that the product flow 1 can be observed through this window 17 by the detection device 11. The wall 16 is thus located between the detection device 11 and the product flow 1 and protects the detection device 11 against all sorts of contaminants such as, for example, dust particles, water or other undesirable elements that may originate from the product flow 1.

In general, the wall 16 is part of a closed housing in which the detection device 11 is mounted. This housing ensures that the detection device 11, in particular components thereof such as, for example, printed circuit boards, lenses, cameras, sensors, etc., are protected against contamination from the environment or originating from the product flow 1. In addition, the housing can prevent any unwanted incidence of light on the sensors of the detection device.

In the embodiment of the sorting device according to the invention as represented in the figures, the window 17 is provided at a level situated below the level of the detection zone 10 in order to observe the bottom side of the product flow 1. The detection device 11 is preferably also provided below the level of the detection zone 10 in this case.

According to the invention, said window 17 is provided at the bottom side of the product flow 1 in order to inspect the bottom of the products 5 and 6. ‘Bottom side’ of the product flow 1 or of the products 5 and 6 in this case means the side corresponding to the side facing the conveyor surface 4 when the product flow 1 is situated thereon. If this conveyor surface 4 contains, for example, an inclined sliding plate, then the detection device 11 may be located laterally to the product flow 1 and the detection zone 10 rather than actually below it.

The window 17 through which the detection device 11 observes the products 5 and 6 is shielded from the product flow 1 by means of a disc-shaped element 18 which is transparent to the detection device 11. Thus, it is possible for the detection device 11 to observe the products 5 and 6 through the window 17 and the disc-shaped element 18.

The disc-shaped element 18 consequently shields the window 17 from the product flow 1 and prevents any unwanted contaminants, dust particles, water, removed products 6, etc. originating from the product flow 1 from moving through the window 17. This prevents sensors or other components of the detection device 11 from becoming contaminated, which would impair its proper functioning.

In order to ensure that the disc-shaped element 18 remains transparent to the detection device 11, it has a rotational axis 19 and works in conjunction with a drive motor 20. This rotational axis 19 extends substantially perpendicular to the surface of the disc-shaped element 18, while the drive motor 20 allows the disc-shaped element 18 to be driven at a relatively high speed around this rotational axis 19. The disc-shaped element 18 is preferably driven at a speed higher than 2,000 revolutions per minute. As a result of the rotation of the disc-shaped element 18, contaminants which are deposited on its surface will be removed from the element 18 by the centrifugal force exerted on it because of this rotational movement.

Additional cleaning means may be provided for the disc-shaped element 18 such as, for example, a sprayer to apply water to its surface to rinse off any contamination. In addition, or alternatively, a compressed air nozzle may open on the surface of the disc-shaped element 18 to clean its surface by means of an air flow.

Thus, the presence of the disc-shaped element 18, which is driven at high speed around the rotational axis 19, allows the detection device 11 to be provided under the product flow 1, wherein it is possible to inspect the bottom of products 5 and 6 almost immediately after they have left the conveying device 2 by means of the detection device 11. This is particularly interesting when the conveying device 2 includes, for example, a substantially horizontal conveyor surface 4 which is connected to the detection zone 10. Indeed, in such a case, thanks to the presence of the detection device 11 with the window 17 and the disc-shaped element 18, it is possible to perform an inspection at the bottom side of the product flow 1 immediately after it has left the conveying device 2, so that the removal device 12 can also be placed at a very short distance behind the conveying device 2. This ensures that irregular products 6 can be removed from the product flow 1 with great accuracy after being detected by the detection device 11.

The detection device, which is protected by the wall 16 and the disc-shaped element 18, may include any system that allows products in the detection zone 10 to be inspected through the window 17 and to be identified. Normally, optical systems are used for the detection device including, for example, a laser scanner with associated sensors, as described in U.S. Pat. No. 4,723,659, or a camera, such as a linear camera or a matrix camera.

The presence of said disc-shaped element 18, which is driven around the axis of rotation 19, then ensures that the operation of the laser scanner or the camera is not disturbed due to the fact that the view of the products through the window 17 and through the element 18 might be obstructed by the precipitation of contaminants such as, for example, dust particles, water or any other undesirable elements that may originate from the product flow 1.

In the embodiment of the sorting device as shown in FIGS. 1 and 2, the detection device includes a camera 21 which is schematically represented by a broken line. More specifically, the detection device 11 has a camera 21 and 22 on each lateral side of the product flow 1, shielded by a corresponding wall 16 provided with an associated window 17. Each of these cameras 21 and 22 has an associated field of view 23 and 24, respectively, which extends through the respective window 17 over at least part of the detection zone 10. The field of view of these combined cameras 21 and 22 extends over the full width of the detection zone 10 and possibly partially overlaps. In this way, products 5 and 6 moving through the detection zone 10 can be observed by at least one of the relevant cameras 21 or 22.

In the sorting device represented in FIGS. 1 and 2, the cameras 21 and 22 with the associated window 17 and the corresponding disc-shaped element 18 are positioned below the conveyor surface 4. This ensures, for example, that sufficient space is available to provide said conveyor chute 15 at the far end of the conveyor surface 4 below the detection zone 10. Furthermore, this reduces the number of contaminants originating from the product flow 1 that could possibly end up on the element 18.

The surface of the disc-shaped elements 18 is preferably inclined with respect to the direction of width of the detection zone 10 and the travel direction 9 of the product flow 1. This inclination is, for example, chosen such that the axis of the cameras 21 and 22 is substantially perpendicular to the surface of the respective disc-shaped element 18. In particular, the axis of these cameras is preferably parallel to the axis of rotation 19 of the associated disc-shaped element 18.

FIG. 3 shows a plan view of a disc-shaped element 18 mounted above a window 17 in the wall 16 of a detection device 11. The disc-shaped element 18 is in this case fixed to the wall 16 via a ring 29. The ring contains an inner bearing for the disc-shaped element 18, as a result of which the latter is freely rotatable around said axis of rotation 19 relative to the ring 29. Said drive motor 20 is fixed centrally on the disc-shaped element 18 and connected to a fixed arm 30 extending through the ring 29 to provide an electrical or pneumatic connection for powering the drive motor 20. Such a disc-shaped element 18 provided with a drive motor 20 is also known by the name ‘spin window’.

In general, said disc-shaped element 18 has a circumference in the form of a circle and said axis of rotation 19 thus extends through the centre of this circle. Said window 17 is usually provided in a position eccentric to this centre point so that the field of view of the detection device 11 is not obstructed by, for example, any motor mounted in the middle of the element 18.

In an alternative embodiment, the detection device 11 may possibly contain only one camera whose field of view extends over the full width of the detection zone 10. It is also possible that two cameras are provided, each placed in a different position below the detection zone 10, such as, for example, below the centre of the detection zone 10 or distributed over its width.

Of course, it is also possible to provide more than two detection devices 11 below the product flow 1, each detection device 11 having a wall 16 with a window 17 and cooperating with its own rotating disc-shaped element 18.

Further, additional detection means may be provided to detect the presence of irregular products 6 in the product flow 1. Thus, as schematically represented in FIG. 1, a laser scanner 25 is provided which scans the top of the products 5 and 6 in the product flow 1 with the aid of a laser 26 as they move in free flight through the detection zone 10. Such a laser scanner 25 for sorting products is known as such to those skilled in the art.

Above the surface 4 of the conveyor belt 3, one or several cameras 27 may be optionally provided, whose combined field of view 28 also extends over the full width of the product flow 1 on the conveyor surface 4. These cameras 27 may for instance be provided to determine the height, size, quality, or other properties of the products 5 and 6 to be sorted or of the product flow 1.

Optionally, the above additional detection means are also shielded from the product flow 1 by a rotating disc-shaped element 18 or ‘spin window’.

Preferably, the sorting device further comprises at least one light source 31 extending below the level of the detection zone 10 and making it possible to illuminate at least the bottom of products 5 and 6 moving through the detection zone 10. This improves the detection of irregular products 6 in the product flow 1. Optionally, this light source 31 may emit light with a particular wavelength or wavelength spectrum which improves the perceptibility of undesirable properties of irregular products by the inspection device. For example, it is possible to use fluorescence properties of the products in the product flow to identify irregular products.

The embodiment of the sorting device from FIGS. 1 and 2 contains two light sources 31. These light sources are, for example, linear and extend substantially parallel to the detection zone 10 or to the transverse direction of the product flow 1.

Instead of said linear light sources 31, as shown in FIGS. 1 and 2, it is also possible for the sorting device to include one or several point light sources, such as, for example, individual light spots, which, for instance, illuminate the bottom side of the product flow 1 as it moves through the detection zone 10. Such point light sources may also be shielded from contamination relative to the product flow 1 by means of a corresponding rotating disc-shaped element 18, in particular a ‘spin window’.

Products that have not been identified as irregular products 6 and that have not been removed from the product flow 1 are collected downstream of the detection zone 10 by a collection device 32. Such a collection device 32 may be formed, for example, by a sliding plate, a conveyor belt, or a container for regular products 5.

The method according to the invention is applied, for example, with the sorting device as described above.

In general, in this method for detecting irregularities in a product flow 1, products 5 and 6 of the product flow 1 move in free flight through a detection zone 10. During this free flight, the product flow 1 is inspected using said detection device 11, and irregular products 6 are thereby identified.

The irregular products 6 are removed from the product flow 1 during said free flight. Further, the detection device of the product flow is shielded by a closed wall 16 in which at least one window 17 is provided, such that the detection device 11 detects the product flow 1 through this window 17.

The window 17 is shielded from the product flow 1 by placing a disc-shaped element 18 between the window 17 and the product flow 1. This element 18 is transparent to the detection device 11. Said disc-shaped element 18 is driven around a central axis of rotation 19 extending perpendicular to its surface in order to remove contaminants from this element 18.

Preferably, in the method, a movement is imposed on the product flow 1 in free flight through the detection zone 10 at a level above the window 17. The bottom of the product flow 1 is thus observed with the detection device.

Preferably, the bottom side of the product flow 1 is illuminated while the products 5 and 6 move in free flight through the detection zone 10.

Of course, the invention is not limited to the above-described embodiments of the sorting device and method. Thus, the detection device may include not only a camera but also a laser scanner or any optical or other known system for sorting a product flow. In addition, the detection device may comprise a combination of different sorting systems and may, for example, comprise a combination of one or several cameras and/or one or several laser scanners which are all protected by a single disc-shaped element 18 or ‘spin window’. It is also possible that multiple windows 17 for different cameras or laser scanners are shielded by the same disc-shaped element 18, also called ‘spin window’.

Further, said window 17 is not necessarily rectangular as represented in the figures, but it may have any shape and may extend, for example, over the entire surface of the disc-shaped element 18.

The disc-shaped element 18 is usually made of transparent glass, but it may of course also be made from other materials which are transparent to the detection device. This disc-shaped element preferably has a relatively even and smooth surface on the side facing the product flow. Furthermore, it is advantageous that the disc-shaped element is rather rigid and has sufficient strength to rotate at the applied speed.

1. A sorting device having a detection zone for detecting irregularities in a product flow moving in free flight through this detection zone in a direction of travel, with a detection device provided for detecting irregular products in the product flow, wherein the detection device is separated from the product flow by a closed wall having at least one window so that the product flow can be detected through said window by the detection device, wherein said window is shielded from the product flow by means of a disc-shaped element which is transparent to the detection device and which can be driven around a rotational axis in order to remove contaminants from said element, wherein said axis of rotation extends substantially perpendicular to the surface of the disc-shaped element.

2. The sorting device according to claim 1, wherein said window is provided opposite said detection zone and opposite the bottom side of the product flow in order to observe this bottom side.

3. The sorting device according to claim 1, wherein said window is provided at a level situated below the level of said detection zone in order to observe the bottom side of the product flow.

4. The sorting device according to claim 1, wherein said axis of rotation axis extends substantially transverse to the plane of said window.

5. The sorting device according to claim 1, wherein said detection device comprises at least one camera whose field of view extends through said window at least over a part of the detection zone such that products moving through this part of the detection zone can be detected by the camera.

6. The sorting device according to claim 1, wherein said detection device includes a camera on each lateral side of the product flow provided with an associated window wherein the field of view of said combined cameras extends across the width of said detection zone.

7. The sorting device according to claim 1, wherein it comprises a conveying device with a conveyor surface for the products of said product flow extending upstream of said detection zone and connecting thereto so that products, upon leaving said surface, move through the detection zone.

8. The sorting device according to claim 7, wherein said conveyor surface is formed by a conveyor belt driven in a direction transverse to said detection zone so that said products, upon leaving this conveyor belt, move in free flight through the detection zone according to said direction of travel.

9. The sorting device according to claim 8, wherein said conveyor surface extends essentially according to a substantially horizontal plane.

10. The sorting device according to claim 7, wherein said conveyor surface comprises an inclined plate.

11. The sorting device according to claim 1, wherein it comprises a removal device cooperating with the detection device to remove irregular products from the product flow during said free flight.

12. The sorting device according to claim 1, further comprising at least one light source extending below said detection zone and making it possible to illuminate products which move through the detection zone.

13. The sorting device according to claim 12, wherein said light source is linear and extends substantially parallel to the detection zone.

14. The sorting device according to claim 12, wherein said light source comprises at least one point light source.

15. The sorting device according to claim 14, wherein said point light source is shielded from said product flow by an additional disc-shaped element which is transparent to light from said point light source and which can be driven around an axis of rotation in order to remove contaminants from said element, said axis of rotation extending substantially perpendicular to the surface of the disc-shaped element.

16. The sorting device according to claim 1, wherein a collecting device is provided extending downstream behind said detection zone to collect said product flow.

17. A method for detecting irregularities in a product flow, wherein products of said product flow are moved in free flight through a detection zone while being inspected with the aid of a detection device wherein irregular products are identified and these irregular products are removed from the product flow during said free flight, wherein the detection device is shielded from the product flow by a closed wall in which at least one window is provided so that the detection device can observe said product flow through said window, wherein said window is shielded from the product flow by placing a disc-shaped element, which is transparent to the detection device, between the window and the product flow, wherein said disc-shaped element is driven around a central axis of rotation extending substantially perpendicularly to the surface of the disc-shaped element in order to remove contaminants from this element.

18. The method according to claim 17, wherein a free flight is imposed on said product flow through said detection zone at a level above the level of said window, wherein the bottom side of the product flow is observed by the detection device.

19. The method according to claim 17, wherein the bottom side of the product flow is illuminated while the products move in free flight through said detection zone.

20. The method according to claim 17, wherein the disc-shaped element is driven around the central axis of rotation at a speed higher than 2,000 revolutions per minute.
